(19) United States
(12) Patent Application Publication
(10) Pub. No.: US 2014/0158632 A1
(43) Pub. Date: Jun. 12, 2014

(54) SELECTIVE SEPARATION OF A SALT FROM WATER

(71) Applicant: Advanced Water Recovery, LLC, Rapid City, SD (US)

(72) Inventors: Rakesh Govind, Cincinnati, OH (US); Robert Foster, Calgary (CA)

(73) Assignee: ADVANCED WATER RECOVERY, LLC, Rapid City, SD (US)

(21) Appl. No.: 14/099,268

(22) Filed: Dec. 6, 2013

Related U.S. Application Data
(60) Provisional application No. 61/734,491, filed on Dec. 7, 2012.
(60) Provisional application No. 61/735,211, filed on Dec. 10, 2012.
(60) Provisional application No. 61/784,099, filed on Mar. 14, 2013.

(51) Int. Cl. C02F 1/52

(52) U.S. Cl. CPC C02F 1/5245
USPC 210/711; 210/714; 210/205; 210/710; 252/175

(57) ABSTRACT

Described herein are methods of separating a first soluble salt from water that contains the first soluble salt and a second soluble salt, by (a) adding a composition to a water product containing a first soluble salt and a second soluble salt, the composition comprising seed crystals composed substantially of a target insoluble salt to be formed from the first soluble salt; and (b) collecting the target insoluble salt. These methods may be used, for example, to separate strontium from water that includes at least one soluble strontium salt and a second soluble salt (such as one soluble calcium salt).

### CROSS-REFERENCE TO RELATED APPLICATIONS

This application claims the benefit of the filing date of U.S. Patent Application No. 61/734,491, entitled “Process for Converting Brackish/Produced Water to Useful Products and Reusable Water”, filed on Dec. 7, 2012; U.S. Patent Application No. 61/735,211, entitled “Process for Converting Brackish/Produced Water to Useful Products and Reusable Water,” filed on Dec. 10, 2012; and U.S. Patent Application No. 61/784,099, entitled “Selective Separation of Strontium from Produced Water”, filed on Mar. 14, 2013, the disclosures of which are incorporated by reference herein in their entireties.

### FIELD OF THE INVENTION

Aspects of the present invention generally relate to methods of separating materials from a liquid, and particularly relate to separating strontium (or other elements) from a liquid such as brackish or produced water.

### Background

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Subsurface geological operations such as mineral mining, oil well drilling, natural gas exploration, and induced hydraulic fracturing generate wastewater contaminated with significant concentrations of impurities. These impurities vary widely in both type and amount depending on the type of geological operation, the nature of subsurface environment, and the type and amount of soluble minerals present in the native water source. The contaminated water is eventually discharged into surface waters or sub-surface aquifers. In some cases, wastewater generated from drilling and mining operations have resulted in making regional water supplies unusable. Induced hydraulic fracturing (a.k.a. hydrofracturing or fracking) in particular is a highly water-intensive process, employing water pumped at pressures exceeding 3000 psi and flowrates exceeding 85 gallons per minute to create fractures in subsurface rock layers, intersecting with natural fractures, thereby creating a network of flow channels to a well bore. These flow channels allow the release of petroleum and natural gas products for extraction. The flow channels also allow the injected water plus additional native water to flow to the surface along with the fuel products once the fractures are created.

Flowback water, or produced water, from subsurface geological operations contains a variety of contaminants. Often, produced water is “hard” or brackish and further includes dissolved or dispersed organic and inorganic materials. One inorganic material that is commonly observed in produced water is strontium. High levels of non-radioactive strontium are known to exist in water drawn from bedrock aquifers that are rich in strontium minerals. Since subsurface geological operations obtain both fuel products and water from bedrock aquifers and nearby areas, the produced water that results is, in some cases, enriched in strontium. In particular, strontium-rich produced water contains strontium in the form of strontium chloride (SrCl₂), a naturally occurring water soluble salt.

Non-radioactive strontium occurs nearly everywhere in small amounts: air, dust, soil, foods, and drinking water all contain traces of strontium. Ingestion of small amounts of nonradioactive strontium is not harmful. The U.S. Environmental Protection Agency (EPA) has developed a lifetime health advisory of 4 mg/L for non-radioactive strontium levels in drinking water (Human Health Hazards publication P00292, 10/2011, prepared by the State of Wisconsin Dept. of Health Services). In other words, water that contains more than 4 mg strontium per liter should not be used for drinking water. Produced water, however, can contain up to 100 mg/L of strontium, in some cases as high as 500 mg/L of strontium.

Previous efforts to separate strontium chloride from produced water have centered on precipitation methodology, employing ion exchange methods that result in the formation of a water-insoluble strontium salt. However, such techniques also result in the precipitation of calcium salts present in the water. Calcium salts, such as calcium chloride (CaCl₂) are often present in significant levels in produced water. In fact, in many cases, the weight ratio of Ca²⁺:Sr²⁺ is between about 10 and 100 and varies greatly depending on the subsurface environment. Since calcium chloride (CaCl₂) and strontium chloride (SrCl₂) have similar solubility in water (and their other salts tend to have very similar solubility as well), it has proven difficult to effectively separate strontium species in water containing both strontium and calcium (i.e., it is difficult to separate strontium from calcium and water, and vice versa).

Among these previous efforts, for example, U.S. Pat. No. 8,158,097 (and related patents and patent applications) describes a method of purifying produced water from hydrofracturing, one step of which includes precipitation of strontium in the form of strontium carbonate. This specialized technique involves adding at least hydrochloric acid, sodium sulfate, and potassium permanganate to the produced water; adjusting the pH to about 3.5 to 4.0; optionally adding a flocculation aid; collecting precipitated barium sulfate; concentrating the effluent; transporting the effluent off-site for continued processing; crystallizing the salt (ostensibly NaCl) from the effluent; adding sodium hydroxide, sodium carbonate, and a flocculation aid to the effluent; adjusting the pH of the effluent to about 11.5 to 12.0; then precipitating strontium carbonate and/or calcium carbonate. Concentration of effluent, required by this procedure, is a highly time and energy intensive process. Further, transferring the partially processed water to a second location is an expensive and inefficient process considering the large volume of water to be addressed in hydrofracturing operations. Overall, this technique is complicated, expensive, and time consuming. Finally, the disclosure makes no assertion regarding the purity of the strontium salts separated.

Other approaches that have been used in the past include U.S. Pat. No. 1,831,251 in which strontium chloride is separated from calcium chloride and magnesium chloride by cooling the liquid to a temperature below 31° C., which is just below the saturation point of calcium chloride. However, in this case, a large amount of calcium chloride is also precipitated together with strontium chloride, and the ratio of concentrations in the precipitate is very close to the ratio in solution. In U.S. Pat. No. 3,029,133, strontium sulfate is obtained by evaporating the water until most of the sodium chloride in the water crystallizes out of solution. Strontium chloride is precipitated with carnallite crystals (KCl.MgCl₂.6H₂O) by cooling the liquid water and strontium chloride is separated from this precipitate by washing with water, which produces a solution with Ca⁺⁺/Sr⁺⁺ ratio of about 2.7. From this solution, strontium sulfate is precipitated by adding a soluble sulfate to form insoluble strontium sulfate. Hence, in this patent, several treatment steps are involved to reduce the molar ratio of Ca⁺⁺/Sr⁺⁺ to below 20 and preferably below 7.

As all previous proceses are complicated, expensive, time-consuming, and do not adequately selectively separate strontium to the exclusion (or near-exclusion) of other materials (such as calcium), there is a need in the industry for a process to preferentially separate strontium from water product—e.g., water that contains at least both strontium and calcium—employing simple, rapid, and inexpensive methodology. Because of its energy and time-intensive requirements, it is desirable in particular to avoid the need to concentrate the water product to facilitate the separation. There is a need to achieve the separation employing materials and equipment suitably and conveniently situated near sites where water product is collected. Carrying out a process on-site, for example in a hydrofracturing operation, requires the separation to be accomplished at a rate that is commensurate with the rate of water product collection.

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Aspects of the present invention overcome the drawbacks in the art described above. One aspect of the present invention provides a composition that facilitates the effective separation of strontium from water. More specifically, disclosed herein is a composition including (a) a water soluble sulfate salt; (b) seed crystals composed substantially of strontium sulfate; and (c) water.

In certain embodiments, the seed crystals have an average particle size of about 30 to 100 microns. In certain embodiments, the composition is a slurry of the crystals in a water soluble sulfate salt solution. In certain embodiments, the composition includes substantially only the recited substituents, except that in any of the disclosed embodiments herein, the water soluble sulfate salt may include one or more water soluble sulfate salts; that is, the water soluble sulfate salt includes mixtures of two or more water soluble sulfate salts. When the composition of the invention is added to a water product, wherein the water product is a solution of water having at least both water soluble strontium salts and water soluble calcium salts dissolved therein, the composition results in the preferential precipitation of strontium sulfate from the water product.

Also disclosed herein is a method of separating strontium from a water product, the method including (a) forming a composition including at least (i) a water soluble sulfate salt, (ii) seed crystals composed substantially of strontium sulfate, and (iii) water; (b) adding the slurry composition to a water product, the water product including at least one soluble strontium salt and one soluble calcium salt; and (c) collecting strontium sulfate.

In certain embodiments, the seed crystals have an average particle size of about 30 to 100 microns.

The method is highly selective for precipitation of strontium over calcium wherein the ratio of soluble calcium ions:strontium ions in the water product is between about 0.010 and 1000 on a weight:weight basis. Thus, for example, in some embodiments the method of the invention provides for precipitation of up to about 80% to 99% of the strontium dissolved in water, wherein the collected precipitant includes equal to or less than about 0.1 wt % to 1% calcium sulfate among the strontium sulfate. In other embodiments, the methods of the invention provide for precipitation of up to 100 wt % of measurable strontium dissolved in water, wherein the precipitant includes equal to or less than about 1 to 10 wt % calcium sulfate.

Conventional methods of removing strontium salts from water products result in substantial contamination of the strontium salts with calcium salts. The strontium thus obtained cannot be used without employing further steps to purify the strontium salts in order to provide utility of the product in industrial applications. In embodiments, the methods described herein result in collection of strontium sulfate that is sufficiently pure, upon drying residual water from the precipitate, to be used directly in such applications. For example, strontium sulfate is industrially useful as a chemical precursor to both strontium carbonate, which is useful in ceramics, and strontium nitrate, which is used in pyrotechnics to impart a red color to fireworks and flares, for example. Strontium metal is also employed in some metal alloys, for example with aluminum or magnesium, for various industrial purposes. Strontium based compounds such as strontium citrate and strontium carbonate, are also used as dietary supplements; strontium ranelate is also available in some countries as a prescription medication useful to treat osteoporosis.

It will be appreciated by one of skill that the methods of the invention are not limited solely to separation of strontium from water that also contains calcium salts. The methods of the invention are useful to preferentially precipitate any insoluble salt from water that contains a mixture of several salts with very similar solubilities. The methods of the invention therefore include (a) identifying a species of soluble salt to be separated from a starting water product; (b) forming a stable slurry including at least (i) seed crystals composed substantially of a target insoluble salt to be formed from the identified soluble salt species, (ii) a reagent capable of forming the target insoluble salt from the identified soluble salt species, and (iii) water; and (c) adding the slurry to the water product.

In certain embodiments, the seed crystals have an average particle size of about 30 to 100 microns.

In some such embodiments, the water product contains two or more soluble salts of similar solubilities, such that separation of individual salt species is not achievable simply by addition of the reagent capable of forming the insoluble salt from the soluble salt species. Stated differently, the methods of the invention are useful for addition to water products where, if the reagent capable of forming the insoluble salt from the soluble salt species is added to the water product without the seed crystals, more than one salt species will form and precipitate, resulting in a mixture of precipitated salt species. In many embodiments, such mixtures of precipitated salt species are inseparable using any practicable method. The methods of the invention result in the selective precipitation of a single targeted salt species present in a water product. In some embodiments, the methods of the invention provide for precipitation of up to about 80% to 99% by weight of the identified soluble salt species dissolved in the water, wherein the precipitant includes the target insoluble salt and equal to or less than about 0.1 to 1% by weight of another salt species. In other embodiments, the methods of the invention provide for precipitation of up to 100% by weight of the identified soluble salt species dissolved in the water product, wherein the precipitant includes equal to or less than about 1% to 10% by weight of another salt species.

Additional advantages and novel features of the invention will be set forth in part in the description that follows, and in part will become apparent to those skilled in the art upon examination of the following, or may be learned through routine experimentation upon practice of the invention.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a schematic view of a seed crystal of strontium sulfate and its use.

FIG. 2 is a schematic view of an apparatus in accordance with the principles of the present invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Further, various embodiments will be described in detail with reference to the drawings, wherein like reference numerals represent like parts and assemblies throughout the views. Reference to various embodiments does not limit the scope of the claims attached hereto. Additionally, any examples set forth in this specification are not intended to be limiting and merely set forth some of the many possible embodiments for the appended claims.

As described above, certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Aspects of the present invention overcome the drawbacks in the art described above. One aspect of the present invention provides a composition that facilitates the effective separation of strontium from water. More specifically, disclosed herein is a composition including (a) a water soluble sulfate salt; (b) seed crystals composed substantially only of strontium sulfate; and (c) water.

In certain embodiments, the seed crystals have an average particle size of about 30 to 100 microns. In certain embodiments, the composition is a slurry of the crystals in a water soluble sulfate salt solution. In certain embodiments, the composition includes substantially only the recited substituents, except that in any of the disclosed embodiments herein, the water soluble sulfate salt may include one or more water soluble sulfate salts; that is, the water soluble sulfate salt includes mixtures of two or more water soluble sulfate salts.

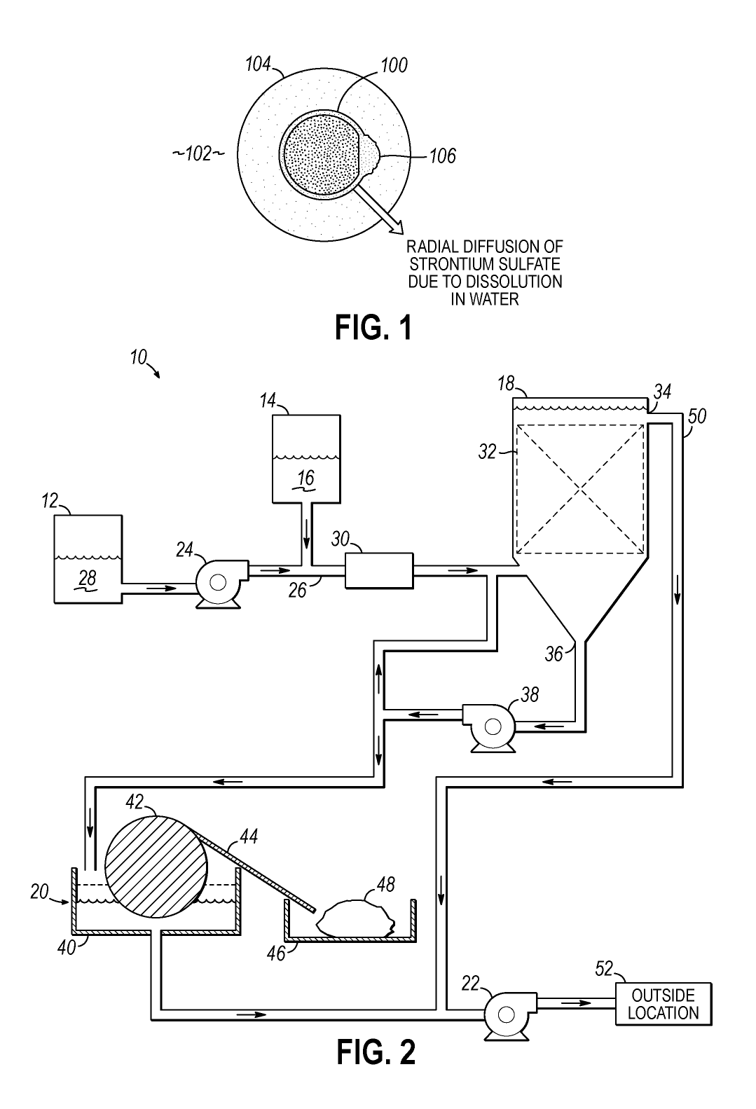

When the composition of the invention is added to a water product, wherein the water product is a solution of water having at least both water soluble strontium salts and water soluble calcium salts dissolved therein, the composition results in the preferential precipitation of strontium sulfate from the water product. Though not being bound by any theory, and with reference to FIG. 1, it is believed that this process works as follows:

Normally, when a chemical crystallizes out of solution, it does so because the concentration of the chemical in the solution exceeds the solubility limit for that chemical. However, when the seed crystals of a particular chemical are used in accordance with the principles of the present invention, the process of crystallization occurs before the solubility limit of the particular chemical is reached. This is due to the following reasons.

First, the portion of the liquid proximal to the seed crystal becomes a near-saturated solution of the chemical comprising the seed crystal. Thus, when additional molecules of this chemical diffuse into this portion of the bulk liquid proximal to the seed crystal, the chemical concentration within that portion of the liquid crosses the solubility limit and crystallization of the chemical occurs. More specifically, FIG. 1 shows two rate phenomena that are occurring simultaneously during this process. The first rate phenomenon is the dissolution of strontium sulfate in a thin film region 104 of water surrounding a seed crystal 100 within the bulk water 102 containing dissolved strontium sulfate. This produces a radial diffusion of dissolved strontium sulfate moving outwards from the surface of the seed crystal 100. The second rate phenomenon is the crystallization 106 of strontium sulfate from the solution surrounding the seed crystal 100, as shown in FIG. 1.

The second reason that crystallization occurs before the solubility limit is reached is due to the energy effect of strontium sulfate, i.e., the heat of dissolution of strontium sulfate in water and the heat of crystallization of strontium sulfate from solution. Crystallization process is controlled by two factors: (1) mass transfer of the salt towards the crystal surface, described in the paragraph above with respect to FIG. 1; and (2) the energetics of the process, which is based on the energy balance.

The process that opposes crystallization is the fact that dissolution of a crystal is favored entropically, while crystallaization decreases entropy. The overall process is hence dependent on both the mass transfer rates, which controls the rate of crystal growth, energetics of the process and the entropy change, which opposes the process, with the net effect being described by the change in free energy, which combines the enegtics and entropy change into one thermodynamic variable.

With respect to the reasons listed above, it is known that the free energy change of seed-crystal assisted crystallization=ΔH−TΔS, where ΔH is the energy change in this crystallization/dissolution process and ΔS is the entropy change, which favors dissolution of the seed crystal. ΔH=Heat of solution−Heat of adsorption, and ΔS=Entropy of strontium sulfate in solution−Entropy of crystallized strontium sulfate. ΔS will be greater than zero, since strontium sulfate in solution has more disorder than strontium sulfate crystallized. Thus, for any spontaneous process, the free energy change has to be negative and as large as possible, hence TΔS>ΔH.

To ensure that AH is as large as possible, strontium sulfate seed crystals are used to assist the crystallization of strontium sulfate preferentially, since this would make the heat of adsorption zero, since strontium sulfate is adsorbing on strontium sulfate seed crystals. On the other hand, precipitation of calcium sulfate using strontium sulfate crystals is not as favorable as precipitation of strontium sulfate, since there is a finite heat of adsorption of calcium sulfate on strontium sulfate. This makes the free energy change of calcium sulfate precipitation less negative than the precipitation of strontium sulfate. The result is that strontium sulfate will preferentially precipitate out of solution.

Also disclosed herein is a method of separating strontium from a water product, the method including (a) forming a composition including at least (i) a water soluble sulfate salt, (ii) seed crystals composed substantially of strontium sulfate, and (iii) water; (b) adding the slurry composition to a water product, the water product including at least one soluble strontium salt and one soluble calcium salt; and (c) collecting strontium sulfate.

In certain embodiments, the seed crystals have an average particle size of about 30 to 100 microns.

The method is highly selective for precipitation of strontium over calcium wherein the ratio of soluble calcium ions:strontium ions in the water product is between about 0.010 and 1000 on a weight:weight basis. Thus, for example, in some embodiments the method of the invention provides for precipitation of up to about 80% to 99% of the strontium dissolved in water, wherein the collected precipitant includes equal to or less than about 0.1 wt % to 1% calcium sulfate among the strontium sulfate. In other embodiments, the methods of the invention provide for precipitation of up to 100 wt % of measurable strontium dissolved in water, wherein the precipitant includes equal to or less than about 1 to 10 wt % calcium sulfate.

Conventional methods of removing strontium salts from water products result in substantial contamination of the strontium salts with calcium salts. The strontium thus obtained cannot be used without employing further steps to purify the strontium salts in order to provide utility of the product in industrial applications. In embodiments, the methods described herein result in collection of strontium sulfate that is sufficiently pure, upon drying residual water from the precipitate, to be used directly in such applications. For example, strontium sulfate is industrially useful as a chemical precursor to both strontium carbonate, which is useful in ceramics, and strontium nitrate, which is used in pyrotechnics to impart a red color to fireworks and flares, for example. Strontium metal is also employed in some metal alloys, for example with aluminum or magnesium, for various industrial purposes. Strontium based compounds such as strontium citrate and strontium carbonate, are also used as dietary supplements; strontium ranelate is also available in some countries as a prescription medication useful to treat osteoporosis.

It will be appreciated by one of ordinary skill in the art that the methods of the invention are not limited solely to separation of strontium from water that also contains calcium salts. The methods of the invention are useful to preferentially precipitate any insoluble salt from water that contains a mixture of several salts with very similar solubilities. The methods of the invention therefore include (a) identifying a species of soluble salt to be separated from a starting water product; (b) forming a stable slurry including at least (i) seed crystals composed substantially of a target insoluble salt to be formed from the identified soluble salt species, (ii) a reagent capable of forming the target insoluble salt from the identified soluble salt species, and (iii) water; and (c) adding the slurry to the water product.

In certain embodiments, the seed crystals have an average particle size of about 30 to 100 microns.

In some such embodiments, the water product contains two or more soluble salts of similar solubilities, such that separation of individual salt species is not achievable simply by addition of the reagent capable of forming the insoluble salt from the soluble salt species. Stated differently, the methods of the invention are useful for addition to water products where, if the reagent capable of forming the insoluble salt from the soluble salt species is added to the water product without the seed crystals, more than one salt species will form and precipitate, resulting in a mixture of precipitated salt species. In many embodiments, such mixtures of precipitated salt species are inseparable using any practicable method. The methods of the invention result in the selective precipitation of a single targeted salt species present in a water product. In some embodiments, the methods of the invention provide for precipitation of up to about 80% to 99% by weight of the identified soluble salt species dissolved in the water, wherein the precipitant includes the target insoluble salt and equal to or less than about 0.1 to 1% by weight of another salt species. In other embodiments, the methods of the invention provide for precipitation of up to 100% by weight of the identified soluble salt species dissolved in the water product, wherein the precipitant includes equal to or less than about 1% to 10% by weight of another salt species.

Additional advantages and novel features of the invention will be set forth in part in the description that follows, and in part will become apparent to those skilled in the art upon examination of the following, or may be learned through routine experimentation upon practice of the invention.

### 1. Definitions

As used herein, the term “water” means pure water, water with some mineral content, water with some organic content, hard water, or brackish water; or combinations of these as determined by context. As used herein, the term “hard water” means water having at least about 30 mg/L, in some cases as much as about 25,000 mg/L, of CaCO₃ dissolved therein. In some cases the hard water has other ionic compounds dissolved or dispersed therein, and/or other materials dissolved or dispersed therein. Hard water can have as much as 300,000 parts per million by weight of total dissolved solids (TDS). As used herein, the term “brackish water” means water having at least about 400 mg/L, in some cases as much as about 80,000 mg/L, of sodium, present as NaCl, dissolved therein. In some cases the brackish water has other ionic compounds dissolved or dispersed therein, and/or other materials dissolved or dispersed therein.

As used herein, the term “produced water” means leachates, flow back, or surface water obtained as the result of, or contaminated with the byproducts of, a subsurface geological operation. In some embodiments the produced water is hard water or brackish water. In some embodiments the subsurface geological operation is hydrofracturing.

As used herein, the term “water product” means water having at least two salt species dissolved therein, wherein the salt species have similar solubilities and reactivities. In embodiments, two salt species having similar solubilities and reactivities are a water soluble calcium salt and a water soluble strontium salt. In embodiments the water product contains additional materials, whether or not dissolved therein, without limitation. The water product is, in some embodiments, hard water, brackish water, salt water, or produced water.

As used herein, the term “treated water product” means a water product that has been treated using the methods of the invention, wherein the treated water product has reduced content of one of the at least two salt species have similar solubilities and reactivities, compared to the water product. In embodiments, the water product has a reduced strontium content compared to the water product, or substantially no strontium content.

Herein, methods and apparatus will be described for the separation of materials, such as strontium, from water. At times, this water may be referred to as “hard” water, or “brackish” water, or “produced” water, or another type of water (which may even include waters not subjected to subsurface geological operations, such as seawater). However, those of ordinary skill in the art will recognize that the methods and apparatus described do not have to be seen as only used with the particular type of water mentioned (whether “wastewater,” “produced,” “hard,” “brackish,” “flowback,” “contaminated,” etc.), but with any water from any source containing a material or materials that one wishes to remove.

As used herein, the term “stable slurry” means a combination of insoluble crystals and one or more reagents in water, wherein the crystals do not have a substantial tendency to agglomerate or grow in size or number, and the reagents and any additional materials present in the slurry do not cause a chemical reaction that results in net formation or dissolution of species within the slurry. Stability is present at least within a selected temperature range and for a selected amount of time. While in some embodiments some or all of the crystals in a stable slurry settle due to gravity when not agitated for some period of time, simple agitation is sufficient to redisperse the crystals without undue effort or shear.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

As used herein, the term “optional” or “optionally” means that the subsequently described event or circumstance may but need not occur, and that the description includes instances where the event or circumstance occurs and instances in which it does not.

As used herein, the term “substantially” means nearly completely, and includes completely. For example, a solution that is “substantially free” of a specified compound or material may be free of that compound or material, or may have a trace amount of that compound or material present, such as through unintended contamination.

### 2. Compositions

In certain embodiments, the compositions of the invention include water, one or more water soluble sulfate salts, and crystals composed substantially of strontium sulfate. In some embodiments of the invention, the composition contains substantially only one or more water soluble sulfate salts, strontium sulfate crystals, and water. The composition may be in the form of a slurry. Other components may be present; for example, one or more soluble salts that are not sulfates, such as sodium chloride, may be present in the compositions (e.g., slurries) of the invention. In various embodiments, one or more of surfactants, thermal stabilizers, water soluble or water dispersible polymers, water soluble cosolvents, pH buffers, or adjuvants may be added to the composition (e.g., slurry). In some embodiments, water soluble or dispersible viscosifying agents such as clays or gums are added to maintain the consistency of the composition and prevent precipitation during use. In some embodiments, calcium salts are excluded from the compositions. In some embodiments, the pH of the compositions is maintained between about 6 and 7.5, for example between about 6.5 and 7.

The water soluble sulfate salts include any compounds that are soluble in water, except protonated sulfate adducts including sulfuric acid and metal hydrogen sulfates, since these compounds bind to the strontium sulfate crystals and prevent further crystal growth. Suitable metal sulfates include, but are not limited to, sodium sulfate, potassium sulfate, lithium sulfate, ammonium sulfate, and magnesium sulfate. In embodiments, the water soluble sulfate is sodium sulfate. In embodiments, more than one soluble metal sulfate is included in the compositions of the invention.

While it is not necessary for the water used to form the composition (e.g., slurry) to be pure, it is desirable in some embodiments to exclude calcium salts, and it is desirable in some embodiments to maintain pH within the range of 6 and 7.5 as discussed above. Generally, purified water such as softened tap water is acceptable to form slurries of certain embodiments. However, substantially pure water is also useful. In some embodiments, the compositions contain substantially only one or more water soluble sulfate salts, strontium sulfate crystals, and water. In some embodiments the compositions contain substantially only one or more water soluble sulfate salts, strontium sulfate crystals, a side product salt as described below, and water. In some embodiments the compositions contain substantially only sodium sulfate, strontium sulfate crystals, and water. In some such embodiments, the compositions further contain sodium chloride.

Strontium sulfate is nearly insoluble in pure water, having a reported solubility of 0.135 g/100 mL at 25° C. and 0.014 g/100 mL at 30° C. Crystals of strontium sulfate in water may be used to form a stable slurry in certain embodiments of the invention. Slurries of strontium sulfate crystals in a water solution containing one or more water soluble sulfate salts are stable slurries. The crystals that are useful for the purpose of separating strontium from other dissolved metal ions in water are composed substantially only of strontium sulfate; that is, only unintentional traces of other materials are present in certain embodiments. Higher purity strontium sulfate crystals correspond to higher purity of precipitated strontium sulfate from the water solutions when the slurries are employed in the methods of the invention. The crystals used in various embodiments of the invention may have an average particle size of about 30 μm to 100 μm, for example about 40 μm to 90 μm, or about 50 μm to 80 μm, and may be round, elongated, irregular, or any other shape, wherein the average particle size reflects the average largest crystal dimension.

The methods employed to form the seed crystals and disperse them in the slurry composition are not particularly limited. Suitable methods of forming the crystals employ conventional techniques well known to those of ordinary skill in the art, including precipitation of strontium sulfate from water, and dividing of celestite or another source of substantially pure strontium sulfate.

Suitable precipitation techniques used to form the seed crystals include any technique whereby a chemical reaction causes strontium sulfate to form in a solution of a water soluble strontium salt. In such embodiments, a water soluble strontium salt is mixed with a water soluble sulfate salt to result in precipitation of strontium sulfate. For example, a solution of substantially pure strontium chloride is formed in water, and then sodium sulfate, or another water soluble sulfate salt such as ammonium sulfate, lithium sulfate, or potassium sulfate, is added to the solution. This may be accomplished by mixing the two dry salts in the water, or by forming separate water-based solutions of strontium chloride and sulfate salt, followed by mixing the two solutions together. It will be appreciated that suitable precipitation techniques result in the in situ formation of strontium sulfate, which is insoluble in water and precipitates to form the seed crystals.

It will be appreciated by one of skill that the starting concentration of the soluble strontium salt, the mode of addition of the sulfate salt (dry addition vs. mixing two solutions) and rate of addition of sulfate salt to the strontium salt, may be selected in order to form strontium sulfate crystals having an average particle size in the range of about 30 μm to 100 μm. In certain embodiments, turbulence in the slurry is maintained during crystal formation, in order to provide for seed crystals forming in the desired size range. The means of providing turbulence is not particularly limited. In one embodiment, for example, mixing sulfuric acid or sodium sulfate solution and produced water containing dissolved strontium chloride in a venturi provides turbulent mixing of the two reactive streams, allowing small seed crystals of strontium sulfate from forming. Alternatively, this could also be accomplished by mixing the two streams in a tank that is well stirred using a mechanical mixer. To ensure that the crystals formed are in the 30-100 micron range, the turbulence of the mixing process has to be kept high, which prevents crystal growth and assists in formation of new crystals. The crystal sizes in the slurry can be measured using standard instrumentation as is known to those of ordinary skill in the art, and thus, one of ordinary skill in the art will be able to optimize the production of the nanobubbles in order to form them in the 30-100 micron range, for example.

In some embodiments, about 10 to 50 mole % of the total amount of the water soluble sulfate salt needed for a stoichiometric conversion to 100% strontium sulfate is added to the solution of strontium chloride solution, or about 10 to 20 mole % of the stoichiometric amount is added to the strontium chloride solution. In embodiments, a higher concentration of strontium sulfate formed requires a higher amount of turbulence during the addition, in order to maintain a seed crystal size of about 30 μm to 100 μm. Similarly, a higher temperature employed during the addition causes a faster rate of reaction and precipitation to occur, further requiring a higher amount of turbulence during the addition in order to maintain a seed crystal size of about 30 μm to 100 μm. Turbulence during the addition is suitably supplied using conventional means, including for example Venturi type mixing apparatuses, impellers, sonicators, static mixers, and the like.

In some embodiments, pH adjustment is carried out by addition of an acid, or a base, or by employing a buffer to maintain a constant pH. Depending on the other chemical components in the mixture, if there are insufficient buffering agents such as bicarbonates and carbonates present, pH will not remain constant. In some embodiments, the formation of strontium sulfate is carried out at ambient temperatures; in other embodiments, one or both slurry components are heated or cooled during formation. It will be appreciated that the addition of heat will increase the rate of reaction, and therefore the rate of precipitation, to form strontium sulfate and the amount of turbulence required to maintain growth of crystals in the range of 30 μm to 100 μm will increase with increasing temperature during the addition. Cooling one or both components of slurry formation will have the effect of lowering the rate of precipitation and therefore the amount of turbulence required to maintain growth of crystals in the range of 30 μm to 100 μm.

In some embodiments, precipitation techniques also cause a side product to form. For example, in the case of the reaction of strontium chloride and sodium sulfate, the side product is sodium chloride. Since sodium chloride is water soluble, in some embodiments the strontium sulfate crystals are retained as a slurry of crystals in a sodium chloride solution. In other embodiments, the crystals are filtered and washed with substantially pure water to remove substantially all the sodium chloride. In some embodiments, a molar excess of the water soluble sulfate salt is added to the soluble strontium salt, to result in a mixture of at least the strontium sulfate crystals and water soluble sulfate salt. In some such embodiments, the slurry composition is a slurry of seed crystals in water, plus water soluble sulfate salt that is useful as a composition of the invention. In such embodiments, any side products of the reaction, such as sodium chloride, are also present in the composition.

Once the reaction of the strontium chloride and water soluble sulfate salt is complete, the slurry compositions are stable; that is, the seed crystals do not tend to further agglomerate or grow, and no further reaction takes place until the slurry is mixed with a water product.

Suitable means to divide a source of pure strontium sulfate, in order to form the seed crystals employed in the slurry compositions of the invention, include grinding and milling. Suitable grinding and milling of strontium sulfate, or celestite (celestine), is accomplished using conventional techniques. Grinding and/or milling is employed to break up coarse strontium sulfate particles, “rocks”, or chunks—for example, having sizes of over 100 μm, such as 1 mm particles or crystals, up to rocks, crystals, or particulate agglomerates having an average diameter of 0.1 meter or even up to 0.5 meter. Grinding and milling operations can be carried out wet or dry. More than one grinding or milling step is suitably employed, for example, a first step to break up large rocks to form smaller rocks or coarse powders; and a second step to break up these products further into particles having an average particle size of 30 μm to 100 μm. Suitable equipment employed to grind or mill such materials include ball mills, media mills, powder grinders, jet mills, vertical mills, and high pressure grinders.

Where strontium sulfate such as celestite is employed as the source of seed crystals in the slurry compositions of the invention, the suitably divided particles are slurried in water and an amount of water soluble sulfate salt is added to the slurry to yield a slurry composition of the invention. It will be appreciated that by using strontium sulfate as the source of seed crystals, it is possible to form a slurry composition including substantially only the seed crystals and the water soluble sulfate salt in water, without any further steps such as filtration of crystals.

In some embodiments, the slurry of seed crystals thus formed, whether alone in water or in the presence of sodium chloride, water soluble sulfate salt, or both, is used as is. In other embodiments, additional water soluble sulfate salt is added to the slurry in order to provide a suitable slurry composition of the invention. The ratio of water soluble sulfate salt to seed crystals in the compositions of the invention is not particularly limited.

### 3. Method of Substantially Separating a Single Salt Species from Water

The methods of the invention are useful to preferentially precipitate a single salt species from water that contains a mixture of at least two salt species with very similar solubilities, and wherein various counterionic species also have similar solubilities. In a non-limiting example, calcium and strontium salts have similar solubilities in water, such that various counterionic species of these metals have similar solubilities in water. Thus, strontium chloride and calcium chloride are highly water soluble, and strontium sulfate and calcium sulfate are nearly water insoluble. Such similarities in soluble species give rise to difficulties in separation. Other examples include calcium and barium.

Conventional water purification methodology involves addition of a reagent capable of forming an insoluble salt from a targeted soluble salt species to the water product, wherein the resulting ion exchange results in the coprecipitation of salt species with very similar solubilities, such as calcium, magnesium, and strontium salts. Sedimentation or filtration of these coprecipitants does yield a treated water product; however, as described above, the coprecipitates are an industrially useless mixture that is impracticable to separate. The salt mixture is thus discarded as a waste product.

The methods of the invention provide a means to form treated water product and industrially useful precipitated salts that are, in embodiments, substantially free of coprecipitated species. Thus, the methods of the invention include (a) identifying a species of soluble salt to be separated from a starting water product; (b) forming a stable slurry including at least (i) seed crystals composed substantially of a target insoluble salt to be formed from the identified soluble salt species, (ii) a reagent capable of forming the target insoluble salt from the identified soluble salt species, and (iii) water; and (c) adding the slurry to the water product.

In certain embodiments, the seed crystals have an average particle size of about 30 to 100 microns.

In some such embodiments, the water product contains two or more soluble salts of similar solubilities, such that separation of an individual salt species is not achievable simply by addition of the reagent capable of forming the insoluble salt from the soluble salt species. In certain embodiments, the reagent is the sulfate solution, which makes the metal sulfates into an insoluble form. We are mainly talking about metals that have very similar properties, and hence having crystals of one metal sulfate will favor selective precipitation of that metal sulfate over the other competing metal sulfates.) Stated differently, the methods of the invention are useful for addition to water products where, if the reagent capable of forming the insoluble salt from the soluble salt species is added to the water product without the seed crystals, more than one salt species will form and precipitate, resulting in a mixture of precipitated salt species. In many embodiments, such mixtures of precipitated salt species are inseparable using any practicable method.

The methods of the invention result in the selective precipitation of a single targeted salt species present in a water product. In some embodiments, the methods of the invention provide for precipitation of up to about 80% to 99% by weight of the identified soluble salt species dissolved in the water, wherein the precipitated target insoluble salt includes equal to or less than about 0.1% to 1% by weight of another salt species. In other embodiments, the methods of the invention provide for precipitation of up to 100% by weight of the identified soluble salt species dissolved in the water product, wherein the precipitant includes equal to or less than about 1% to 10% by weight of another salt species.

### 4. Method of Separating Strontium from Water

One particular embodiment of the invention includes a method of treating a water product to separate strontium ions from other dissolved ions in water products, in particular wherein the dissolved ions include at least calcium ions. In some embodiments, the dissolved ions further include magnesium ions or barium ions or a mixture thereof. In some embodiments, the water includes other dissolved or dispersed solids and/or ionic compounds. In some such embodiments, the water product contains dispersed or dissolved liquids or gels. In some embodiments, the water product includes hydrocarbon compounds, surfactants, petroleum products, dispersed sand or silt, or mixtures thereof. In embodiments, the water product is hard water or brackish water. In embodiments, the water product is produced water. In some such embodiments, produced water is the product of hydrofracturing.

In embodiments, the water product is pretreated prior to the carrying out the methods of the invention. In some such embodiments, a suitable pre-treatment includes the removal of insoluble but dispersed solids, liquids, and gels from the water product, for example the removal of hydrocarbons dispersed in the water product. Such removal is, in embodiments, carried out according to methods known by those of skill in the art of water purification. Suitable removal techniques include sedimentation, flotation, and filtration. Other pretreatments that are carried out in some embodiments include aeration, evaporation, acidification, and the like, according to the knowledge of the skilled artisan. However, it will be recognized that an advantage of the current invention is that no pretreatment of water product is necessary prior to carrying out the methods disclosed herein. The methods of the invention are effective to selectively separate strontium from other metal ions in water product without any pretreatment whatsoever. Further, it is an advantage of the current invention that where the water product is produced water, a simple pretreatment to remove insoluble but dispersed solids, liquids, and gels from the produced water is sufficient to provide a water product from which substantially pure strontium sulfate is easily collected.

In certain embodiments, the water product that is the starting material from which strontium will be obtained may contain a total of 130 to 300,000 mg/L of total dissolved solids. In some such embodiments, the water product is produced water, wherein produced water is a product of hydrofracturing or another mining operation. In embodiments, the soluble strontium salt that is the source of strontium ions in the water product is strontium chloride, or SrCl₂. In embodiments, the soluble metal salts that are the source of other metal ions in the water product include calcium chloride, or CaCl₂. In certain embodiments, the water product may contain about 10 to 50,000 mg/L of calcium ions. In certain embodiments, the water product may contain between about 1 to 1000 mg/L of strontium ions. In certain embodiments, the ratio of soluble calcium salts to soluble strontium salts in the water product may be about 0.01 to 1000, or about 0.1 to 500, or about 1 to 100, or about 5 to 50. In certain embodiments, the water product further includes water soluble magnesium salts, water soluble barium salts, or both.

a) The method of separating strontium from water in this embodiment of the invention includes (a) forming a slurry composition including water, one or more water soluble sulfate salts, and crystals composed substantially of strontium sulfate; (b) adding the slurry composition to a water product, the water product including at least one soluble strontium salt and one soluble calcium salt; and (c) collecting strontium sulfate.

In some embodiments, the methods of the invention are carried out between about 10° C. to 150° C. In embodiments where the temperature employed is near or in excess of 100° C., an enclosed vessel system is employed; in some such embodiments, additional pressure is added to the enclosed vessel. In embodiments, the rate of separation, and therefore collection, of strontium is observed to increase with increasing temperature.

In some embodiments the ratio of soluble calcium:strontium ions in the water product prior to carrying out the methods of the invention is between about 0.01 and 1000 on a weight: weight basis. In some such embodiments, the methods of the invention provide for precipitation of up to about 80% to 99% by weight of the strontium present in the water product, wherein the collected strontium sulfate precipitant includes equal to or less than about 0.1% to 1% calcium sulfate by weight. In other embodiments, the methods of the invention provide for precipitation of up to 100% by weight of the strontium in the water product wherein the precipitant includes equal to or less than about 1% to 10% calcium sulfate by weight. In embodiments, strontium sulfate is collected at the end of the process, and treated water is the second product that is collected. The treated water is the water product after treating using the methods of the invention, wherein between about 80% and 100% by weight of measurable strontium in the water product is removed, or between about 90% and 99% by weight of measurable strontium in the water product is removed to result in the treated water.

In some embodiments, it is advantageous to determine the amount of strontium present in the water product prior to carrying out the addition of the slurry composition to the water product. In these embodiments, once this amount of strontium is determined, the amount of slurry composition added to the water product corresponds to about one molar equivalent of water soluble sulfate salt in the slurry composition per mole of strontium present in the water product. While it is not necessary to determine the amount of strontium in a water product prior to carrying out the method of the invention, this determination can lead to a greater yield of isolated strontium sulfate and can further minimize the amount of excess water soluble sulfate salt added to the treated water product. Methods that are useful to determine strontium levels in the water product include, but are not limited to, spectrophotometric methods such as atomic absorption spectrophotometry.

Once the amount of strontium in the water product has been determined, an amount of the slurry concentration is added to the water product. In embodiments where the water product is treated in batch mode, the slurry composition is added in a single batch to the total volume of water product. In other embodiments, the slurry composition is added in aliquots to a batch of water product. In some such embodiments, precipitated strontium sulfate is collected after each aliquot is added, then a subsequent precipitation and collection step is carried out, for example, in a separate vessel. In embodiments where the water product is treated in continuous mode, the slurry composition is added continuously at a rate that is based on the volume of water product moving into and out of a treatment vessel where the strontium is to be separated. In one embodiment, the two streams are mixed in a venturi to provide sufficient turbulence to allow proper mixing of the slurry with the produced water flow.

In another embodiment of the invention, a mixture of ground or milled strontium sulfate having a particle size of about 30 μm to 100 μm is mixed as a dry powder with a dry water soluble metal salt, and the dry mixture is added to the water product. In some such embodiments, a means of dispersing the dry components in the water product is useful. Suitable means for dispersing include but are not limited to impeller mixing, static mixing, sonication, shaking, tumbling, combinations thereof, and the like. In various embodiments, a batchwise or continuous mode of addition of the dry mixture to the water product is used.

In certain embodiments, the slurry may be added in a total amount corresponding to about 50 mole % to 150 mole % of soluble sulfate salt to soluble strontium salt in the water product; or about 70 mole % to 130 mole % of soluble sulfate salt to soluble strontium salt in the water product; or about 90 mole % to 100 mole % of soluble sulfate salt to soluble strontium salt in the water product; or about 90 mole % to 120 mole % of soluble sulfate salt to soluble strontium salt in the water product. In a particular embodiment, the slurry composition contains a suitable ratio of strontium sulfate seed crystals to water soluble sulfate salt to provide utility in the methods of the invention with respect to a particular water product. That is, a selected volume of the slurry contains an approximately a stoichiometric amount of water soluble sulfate salt to water soluble strontium salt in the water product, when the selected volume of slurry composition is added to a selected volume of the water product. Further, in this particular embodiment, the selected volume of slurry composition contains a suitable amount of seed crystals of strontium sulfate to provide for the selective precipitation of strontium sulfate.

In such an embodiment, the “suitable amount” of seed crystals may be determined as follows: The aqueous solubility of strontium sulfate is known to be 1.4×10⁻⁴ gms of strontium sulfate per gram of water, at 30° C. This corresponds to a concentration of 140 ppm of strontium sulfate in water. The concentration of strontium chloride in Marcellus Shale water, for example, is 2,500 ppm (the Marcellus Shale is an area of marine sedimentary rock found largely in the eastern to northeastern part of the United States, and contains natural gas reserves—with Marcellus Shale, water being water, such as flowback water from fracking, in the Marcellus Shale). Since SrCl₂+Na₂SO₄→SrSO₄+2NaCl, that means 158.52 gm of SrCl₂ will form 183.62 gms of SrSO₄ (strontium sulfate). Thus, 2,500 ppm of SrCl₂ in Marcellus Shale Water will form 2,896 ppm of strontium sulfate in the water.

Clearly the strontium sulfate solution will be supersaturated and the ratio of supersaturated and saturated solution concentration will be=∝=2896/140=20.7. In section [0085] we had calculated that 2,500 ppm of SrCl2 will form 2,896 ppm of strontium sulfate in water. 140 ppm is the solubility of strontium sulfate in water at 30° C., as per section [0085]. Since the solution is highly supersaturated, the number of seed crystals required will be small.

The preferential formation of strontium sulfate over calcium sulfate is caused by nucleation of strontium sulfate by the seed crystals, resulting in isolation of substantially pure strontium sulfate from the water. The rate of nucleation is given by the following equation (Preckshot, G. W. and G. G. Brown, Ind. Eng. Chem., 44:1314(1952))

$${B}^{o} = {10}^{25} exp [ - \frac{16 π {V}_{M}^{2} {N}_{a} {σ}_{a}^{2}}{3 {( RT )}^{3} {υ}^{2} {s}^{2}} ]$$

where B⁰=nucleation rate (number/cm²·s)
Nₐ=Avogrado Number=6.0222×10²³ molecules/gmole
R=Gas Constant=8.3143×10⁷ ergs/gmole·deg K

### C=Frequency Factor

V_{M}=Molar volume of crystal
σₐ=average interfacial tension between solid and liquid s=α−1 where a is Supersaturated Solution Conc./Saturated So ln. conc.
ν=number of ions per molecule of solute

The factor C (listed above) does not appear in the equation above, but is a statistical measure of the rate of formation of crystals that reach a critical size. It is proportional to the concentration of the individual particles and to the rate of collision of these particles with a crystal of the critical size required to form a stable nucleus. It is of the order of 10²⁵ nuclei/cm³·s. Its accurate value is not important since the kinetics of crystallization is dominated by the Ln∝ term in the exponent.

The value of a in the above equation, which is the interfacial tension between the crystal and solution is about 80-100 ergs/cm² for typical salts. (See, CRC Handbook of Chemistry and Physics.)

V_{M} for Strontium Sulfate=Mol. Wt/Crystal Density=183.68/3.96=46.38 cm³/gmole.

The exponent in the above equation is

$$= - \frac{16 {π ( 46.38 )}^{2} \times 6.0222 \times {10}^{23} \times {2.5}^{3}}{3 {( 300 \times 8.3134 \times {10}^{7} )}^{3} {( 3 )}^{2} {( 19.7 )}^{2}} = - 38.94$$

The value of B⁰=1,230 nuclei/cm³·s. This gives the number of seed crystals that have to be added to the vessel, as can be calculated by one of ordinary skill in the art given the above equations.

We have found that the amount of seed crystals added to the water affects the rate of precipitation of strontium sulfate from the water, but does not affect the yield. (Yield is the net amount of strontium sulfate precipitated. The amount of seed crystals added affects the rate of precipitation, not the total amount recipitated, which depends on the amounts of the chemicals that have been added, i.e., stoichiomery.) Thus, in applications involving very high continuous rates of water product throughput, an increased ratio of crystals provided in the slurry composition of the invention relative to the amount of water product is usefully employed in order to increase the rate of strontium sulfate precipitation from the water product. The use of a higher ratio of seed crystals to water product affects, in turn, the ratio of seed crystals to water soluble sulfate salt employed in the slurry compositions, since the amount of water soluble sulfate salt depends on the amount of strontium in the water product and the activity thereof depends only on the rate of mixing.

In embodiments, strontium sulfate is collected at the end of the process, and treated water product is also collected. The treated water product includes, in embodiments, about 0% to 10% by weight of strontium initially measured in the water product, or between about 0.1% and 5% by weight of strontium initially measured in the water product. The treated water product further contains, in embodiments, between about 90% and 100% by weight of the measurable calcium ions that were present in the water product initially, or about 95% and 99% by weight of the measurable calcium ions that were present in the water product initially. In other words, the methods of the invention remove little to no calcium while removing a large proportion or all of the strontium from the water product. In embodiments, the treated water product is substantially free of strontium. In some embodiments the treated water contains one or more side products as defined above, that is, a salt that is added to the slurry composition by virtue of employing in-situ precipitation methodology as described above. In some embodiments, the treated water product further contains one or more additional additives employed in the slurry compositions of the invention and therefore added to the water product employing the methods of the invention. In some embodiments, the treated water also contains the chloride salt that is the product formed as the water soluble sulfate salt reacts with strontium chloride to form strontium sulfate. Thus, in embodiments, magnesium, ammonium, sodium, lithium, or potassium chloride is present in the treated water as a result of the reaction of strontium chloride with the water soluble sulfate salt to form strontium sulfate.

In embodiments, the process to remove strontium from the water product is repeated with other ions once the separation of strontium is complete. For example, once the strontium is substantially removed from the water product, the treated water product is subsequently treated again to selectively remove calcium ions and thereby separate calcium from e.g. magnesium salts also present in the treated water product. In such embodiments, a method similar to any of the above embodiments of the method to remove strontium is repeated, only using seed crystals of calcium sulfate in a slurry with a water soluble sulfate salt such as sodium sulfate. In still other embodiments, the method of the invention is carried out to separate calcium from the water product, followed by separation of strontium. In still other embodiments, the method of the invention is carried out to separate magnesium from the water product, followed by separation of strontium, calcium, or another salt of similar solubility, in any order as will be selected by one of skill. In some embodiments, it is desirable to determine the amounts of various salts in the water product, and select the order of removal such that the ion present in the highest concentration is removed first, or the ion of lowest concentration is removed first, or some other order based on efficiency and equipment considerations.

### 5. Apparatus Useful for Selectively Separating Strontium from Water

Apparatus that are useful for carrying out the methods of the invention will now be described. It will be appreciated by those of skill that the various apparatus described are provided by way of illustration only and that various modifications and changes may be made without following the examples of embodiments and applications illustrated and described herein, wherein such modifications and changes are within the scope of the apparatus of the invention. It will also be appreciated that while the apparatus described are intended for the indicated precipitation of strontium, the apparatus or individual features thereof are useful for carrying out the broader methods of the invention; that is, the addition of stable slurries to water products, and isolation of a resulting target insoluble salt and a treated water product.

FIG. 2 shows one embodiment of an apparatus 10 of the invention. Apparatus 10 includes a source 12 of water product, a tank 14 to hold the slurry composition 16, a precipitator vessel 18, a collecting apparatus 20, and a system (pump) 22 for removing treated water product.

The source 12 of water product is not particularly limited. The source 12 is, in various exemplary embodiments, a wellbore; a pipe or tube connected to a wellbore or to some other flowing source of a water product; a holding tank containing the water product, wherein the holding tank has, in some embodiments, a separate pump system (not shown) to provide flow of the water product to the apparatus 10; or a pretreatment system that produces the water product as the product of the pretreatment process. In some embodiments, source 12 is connected to regulator 24. In some such embodiments, regulator 24 is a pump that pulls water product into the apparatus 10. In some embodiments, regulator 24 regulates water flow, for example by creating back pressure or by shunting excess volume to a holding tank (not shown). In still other embodiments, regulator 24 is some other means of controlling overall volume and rate of flow of water product. Source 12 of water product is further connected to tank 14 in a manner such that a combined flow 26 of the water product 28 and a slurry composition 16 of the invention is formed. Tank 14 is equipped to hold and dispense a slurry composition 16 of the invention such that a combined flow 26 of water product 28 and slurry composition 16 is formed and directed towards and into mixing apparatus 30. Tank 14 has, in some embodiments, a flow regulator (not shown) to regulate or meter the rate of flow of slurry composition 16 into the water product 28 to form combined flow 26.

Mixing apparatus 30 receives and mixes the combined flow 26 and delivers it to precipitator vessel 18. Mixing apparatus 30 may be an in-line mixer capable of mixing the combined flow 26 to provide a substantially constant distribution of the seed crystals therein. In various embodiments, the mixing apparatus 30 is a static mixer, an impeller mixer, a vortex mixer, or another means for mixing as will by understood by those of skill in the art.

In some embodiments, apparatus 10 does not include tank 14 for holding the slurry composition 16. In such embodiments, various alternative means of supplying both a water soluble sulfate salt and seed crystals of strontium sulfate are used with equal advantage to supplying slurry composition 16 to the source 12 of water product 28. For example, dry powder metering systems for addition of seed crystals, water soluble sulfate salt, or a single apparatus for providing a blend of both components are employed in some embodiments to deliver the dry material components directly to the water product 28 as it flows into the mixing apparatus 30, whereupon the components are mixed directly into the water product. Where added separately, the order of addition of the components is not limited; however, in some embodiments, it is advantageous to add the seed crystals prior to addition of the water soluble sulfate salt since the salt initiates the reaction to precipitate the strontium sulfate and it is desirable to provide the seed crystals at the outset of the reaction. In particular embodiments, the seed crystals have to be added before the addition of the soluble sulfate, so that the strontium sulfate precipitates preferentially on these seed crystals instead of the calcium sulfate, especially since the calcium in concentration is much higher than the strontium ion.

In another alternative embodiment, there are two tanks (not shown) attached in a manner that is suitable to provide materials to the source 12 of water product 28, wherein one tank holds a solution of water soluble sulfate salt, and the second holds a slurry of strontium sulfate seed crystals. The tanks are used to feed their respective materials to the source 12 of water product 28 prior to form the combined flow 26 that enters mixing apparatus 30. The two tanks add the strontium sulfate slurry and the solution of water soluble sulfate salt contemporaneously or in series to the water product 28 to form combined flow 26. The order of addition of the individual tank components is not limited; however, in some embodiments, it is advantageous to add the seed crystal slurry prior to addition of the solution of water soluble sulfate salt since the salt initiates the reaction to precipitate the strontium sulfate and it is desirable to provide the seed crystals at the outset of the reaction.

After the combined flow 26 is mixed using mixing apparatus 30, the substantially homogeneously dispersed combined flow 26 is dispensed into the precipitator vessel 18. The vessel 18 is designed to provide the requisite residence time to allow for completion of the reaction to form strontium sulfate from strontium chloride present in the combined flow 26, and to allow for sedimentation of the strontium sulfate precipitate that forms as a result of the seeded precipitation reaction. The precipitation and sedimentation is adjusted by the rate of addition of components of the combined flow 26, relative amounts of the components of the combined flow 26, and flow rate of the combined flow 26. The seeded crystal precipitation, and sedimentation of the precipitants formed, is aided by in-line media 32. In-line media 32 includes tubes, plates, baffles, or the like, for example inclined plates or tubes that serve to increase surface area inside precipitator vessel 18; or, in other embodiments, prevent turbulence during addition of incoming combined flow 26 from mixing apparatus 30; or in yet other embodiments accomplish both increase of interior surface area and prevention of turbulence in the interior of vessel 18. Residence time of the combined flow 26 within the vessel 18 is carefully determined based on rate of precipitation and sedimentation.

As the strontium sulfate precipitates from the combined flow 26, treated water product is removed via top port 34 and a concentrated slurry of strontium sulfate in treated water is removed via bottom port 36. The concentrated slurry of strontium sulfate exiting vessel 18 via bottom port 36 is transported via regulator 38 to the collecting apparatus 20. In some embodiments, regulator 38 is a pump that assists the concentrated slurry of strontium sulfate to flow into collecting apparatus 20. In some embodiments, regulator 38 regulates flow of the concentrated strontium sulfate slurry, wherein excess volume is directed to, for example, a holding tank or other apparatus (not shown). In some embodiments, regulator 38 further includes an in-line mixer or other apparatus for maintaining a substantially uniform slurry flow directed toward collecting apparatus 20.

Collecting apparatus 20 is generally a filtration means capable of separating strontium sulfate solids from the concentrated slurry of strontium sulfate, resulting in wet solid strontium sulfate and treated water. While apparatus 10 is not particularly limited in the type of collection apparatus 20 employed, in the embodiment of apparatus 10 shown in FIG. 2, the collection apparatus 20 is a cylinder former.

The concentrated strontium sulfate slurry in treated water is deposited into a vat 40 that is part of collection apparatus 20. Collection apparatus 20 as shown is the same or similar to cylinder formers developed for papermaking applications, as will be appreciated by those of skill. Collection apparatus 20 includes a horizontally situated cylinder 42 with a wire, fabric, or plastic cloth or scrim surface that rotates in the vat 40 containing the concentrated strontium sulfate slurry from vessel 18, as dispensed from bottom port 36 and transported via regulator 38. Treated water associated with the slurry is drained through the cylinder and a layer of strontium sulfate precipitate is deposited on the wire or cloth. The drainage rate, in some designs, is determined by the slurry concentration and treated water level inside the cylinder such that a pressure differential is formed. As the cylinder turns and treated water is drained, the precipitate layer that is deposited on the cylinder is peeled or scraped off of the wire or cloth, such as with a scraper blade (not shown) and continuously transferred, such as via a belt 44 or other apparatus, to receptacle 46. In some embodiments, during transport of the deposited layer of strontium sulfate to the receptacle 46, the strontium sulfate is washed, such as by applying a spray of clean water (not shown) across the belt 44 that transports the strontium sulfate to receptacle 46. In some embodiments, during transport of the deposited layer of strontium sulfate to the receptacle 46, the strontium sulfate is dried, such as by applying a hot air knife (not shown) across the belt 44 that transports the strontium sulfate to receptacle 46 or by heating belt 44 directly, or by some other conventional means of drying strontium sulfate crystals. Receptacle 46 thus contains a collection, such as an agglomerated “rock” or “chunk” of wet strontium sulfate 48.

In some embodiments, the strontium sulfate 48 is used for an industrially useful application as is discussed above. In some embodiments, a portion of the strontium sulfate 48 is partitioned from the collected amount and redeployed as a source of seed crystals to be used in the slurry 16 or a dry feed of seed crystals used to form the combined flow 26. In such embodiments, it may be necessary to grind or mill the collected and partitioned strontium sulfate using a conventional grinding or milling apparatus such as those described above. In still other embodiments, the collection apparatus 20 is configured to allow strontium particles having particle sizes of about 30 μm to 100 μm to flow through the filtration means (cloth, wire, etc.) to be captured elsewhere, such as by traditional nonwoven or membrane filtration or the like, and these small particles are washed and used as seed crystals in the slurry composition 16.

In still other embodiments, a portion of the concentrated slurry collected from exit port 36 is partitioned from the main channel transporting the flow to the collection apparatus 20 and this partitioned portion of slurry is filtered and washed to collect seed crystals of strontium sulfate to be used in slurry composition 16.

An alternative type of cylinder former (not shown) useful in conjunction with apparatus 10, causes the concentrated strontium sulfate slurry to be deposited directly along the rotating cylinder. The area of the cylinder contacting the slurry, called the “forming area,” is restricted compared to that of vat designs. This type of cylinder former design has no associated vat, as slurry is applied directly to the cylinder that is the same as or similar to cylinder 42. Such cylinder former designs are called “dry vat” type formers. Suction formers are dry vat type formers that further utilize vacuum dewatering inside of the cylinder. The greater rate of treated water removal afforded by vacuum dewatering facilitates increased line speed relative to “gravity” type drainage. Pressure formers are another dry vat type variation that employ a pressurized slurry instead of vacuum suction as a means to control the pressure differential. Any of these embodiments of cylinder formers are useful as the cylinder former 20 in apparatus 10 of the invention, as well as variations thereof as will be appreciated by those of skill.

The treated water product removed via top port 34 is carried via tubes, pipes, or the like 50 to be combined with the treated water product drained or suctioned from the interior of cylinder 42, and the combined treated water product is collected via regulator 22 and conveyed to outside location 52. Outside location 52 is, in various embodiments, an additional treatment apparatus, a holding tank, or some other location where the treated water product is used, subjected to further treatment, or dispensed.

The apparatus 10 has, in various embodiments, additional control and infrastructure features that provide for greater rates of strontium sulfate recovery, greater efficiency, greater yield, and the like as will be appreciated by one of skill. Valves, gauges, pipes, tubes, coolant jackets or other means of temperature adjustment, means of measurement in-line, electronic controls or measurements, feedback controls digitally connected in cooperation with in-line measurements, and the like are optionally added at any location in apparatus 10. For example, an in-line atomic absorption spectrometer may be added in-line for water product source 12, prior to addition of slurry 16, in order to determine strontium level in the water product source 12. The data may be continuously fed to a metering regulator attached to tank 14 to control the rate of addition of slurry 16, such that an optimized amount of slurry 16 is added to form combined flow 26. Many other such features are easily envisioned by one of skill. In some embodiments, vessel 14 is enclosed in order to allow pressure to be applied or to develop inside vessel 14 and, in some such embodiments, elsewhere within the apparatus 10. In some such embodiments, vessel 14 includes a source of heat in order to raise the temperature of the water product to as high as 150° C. In some embodiments, the source 12 of water product is a heated source.

In some embodiments, the apparatus 10 shown in FIG. 2 is expanded to include several precipitation vessels 18, wherein aliquots of slurry are added in each vessel, a partially treated water product is removed via top port 34 and a concentrated slurry of strontium sulfate in partially treated water is removed via bottom port 36; then the partially treated water product removed via top port 34 is carried via tubes, pipes, or the like 50 to be combined with a partially treated water product drained or suctioned from the interior of cylinder 42, and the combined partially treated water product is collected via regulator 22 and conveyed to outside location 52 wherein the outside location 52 is another precipitation vessel 18. In the second precipitation vessel, a subsequent aliquot of slurry from the same source tank 14 or a different source is added to the partially treated water and the precipitation and collection of treated water product is repeated. In this manner, two or more such precipitation steps are carried out to result in a treated water product. In some embodiments where two or more such precipitation steps are carried out, strontium sulfate is collected separately in each step; in other embodiments, the precipitates of each step are combined, either after collection and filtration or by transferring the precipitates to the same collection apparatus and combining prior to filtration.

In some embodiments of apparatus 10, the slurry source tank 14 is not used, and instead a separate source of water soluble sulfate salt and strontium sulfate crystals are used. Then these two slurry components are mixed in-line, such as by mixing apparatus 30 or a separate similar to in-line mixing apparatus 30, just before or contemporaneously with addition of the slurry to the water product. In such embodiments, the ratio of seed crystals to water soluble sulfate salt is easily adjusted based on measured amounts of strontium and/or other salt species present in the water product as the source of the water product changes. An additional advantage of this approach is realized when the apparatus 10 shown in FIG. 2 is expanded to include several precipitation vessels 18, wherein aliquots of slurry are added in each vessel: the ratios of water soluble sulfate salt to seed crystals is easily adjusted for each tank such that an ideal ratio of slurry components is provided for each step in order to maximize yield and purity of the precipitate, for example based on the actual collected yield of strontium sulfate collected in the previous step. Finally, providing the slurry components separately allows for flexibility in order of addition: in some embodiments, seed crystals are added to the water product, followed by addition of the water soluble sulfate salt. In other embodiments, the water soluble sulfate salt is added to the water product, followed by addition of the seed crystals. Such flexibility in order of addition allows for optimization of the process based on the source and composition of water product to be treated.

In some embodiments, a similar apparatus to apparatus 10 shown in FIG. 2 is employed to carry out a separation of insoluble salt other than strontium salts from a water product. For example, in some embodiments, hard water contains negligible or acceptable amounts of strontium salts and thus strontium separation is unnecessary; however, hard water typically contains large concentrations of calcium and thus calcium removal is desirable. The methods of the invention, as described above, are also useful for separation of calcium sulfate from water products containing salts of similar solubility and reactivity to calcium chloride. The methods of the invention are therefore useful for selective separation of calcium sulfate from such water products to result in collection of a substantially pure calcium sulfate product. That is, a slurry composition of calcium sulfate seed crystals and a water soluble sulfate salt is employed to selectively separate calcium sulfate from the water product, using materials and methods as described above. In other similar embodiments, it is desirable to selectively separate both calcium and strontium from a water product; in such embodiments, apparatuses such as apparatus 10 shown in FIG. 2 are useful wherein strontium is separated in one or more steps and calcium is also separated in one or more additional steps by sending the treated water product from one separation to a separate apparatus 10 for a subsequent separation. The order of separation is selected by the practitioner for efficiency and may be based, for example, on the composition of the water product. Each such step employs a source of seed crystals that preferentially precipitates the desired product as described above. In some such embodiments, the same water soluble sulfate salt is employed to preferentially precipitate different salt species; in other embodiments, the water soluble sulfate salt is different in each addition of slurry to the water product or partially treated water product.

Similarly to the methods described above, two, three, or more salts with similar solubilities and reactivities are selectively separated from a single water product. The compositions, methods, and apparatuses employed in carrying out two or more such separations are not particularly limited. It is an advantage of the compositions, methods, and apparatuses of the invention that the practitioner has flexibility in providing for such separations to meet the requirements of the type of water product expected as well as the volume of flow of the water product, the desired amount of selective capture of substantially pure precipitated sulfate salts, and the like.

The various aspects of the present invention will be described in greater detail with respect to the following Examples.

### EXAMPLES

Background

As described above, produced/brackish water may contain strontium together with calcium and other inorganic contaminants. Typically, the concentration of calcium in the water is much higher than strontium, with a Ca⁺⁺/Sr⁺⁺ ratio in the range of 10-50. And since these two contaminants are very similar in terms of the aqueous solubility of their salts, it is difficult to selectively separate strontium.

As described above, one aspect of the present invention is the separation of strontium from produced/brackish water with little or no precipitation of calcium, even though the concentration of calcium is typically much higher than strontium. This aspect involves the preferential precipitation of strontium from water by pre-mixing the water with seed crystals of strontium sulfate. This approach can be used to preferentially precipitate any insoluble salt from water that contains a mixture of several salts with very similar solubilities, like salts of calcium and strontium.

The relevant chemical precipitation reactions for the following Example 1 are:

SrCl₂+Na₂SO₄→SrSO₄+2NaCl (2.1)

SrCl₂+MgSO₄→SrSO₄+MgCl₂ (2.2)

The total amount of soluble sulfate species (Na₂SO₄, MgSO₄) added may be in accordance with the stoichiometric amount needed to precipitate the strontium. To initially form the seed crystals of strontium sulfate, about 10-50% of the total amount of soluble sulfate needed stoichiometrically is added. These seed crystals are then added to the water to preferentially precipitate the strontium sulfate. The seed crystals can also be introduced by using a mineral like celestite or by precipitating from a pure solution of strontium chloride using a soluble sulfate, as given by reaction (2.1), above.

The amount of seed crystals determines the rate of precipitation of strontium sulfate. However, it does not affect the yield of strontium sulfate precipitated from the water.

Typically, various embodiments of the present invention can be practiced between the temperatures of 10-150° C., with the higher temperature being used when the liquid is under pressure. The rate of precipitation decreases as the temperature decreases, and vice versa.

### Example 1

500 mL of produced water containing 442 mg/L strontium chloride and 6,200 mg/L calcium chloride (giving a Ca⁺⁺/Sr⁺⁺ wt ratio of 14.0 and molar ratio of 20.0) was used in this Example. The temperature was maintained at 25° C., and small amounts of sodium sulfate (Na₂SO₄) were added and mixed with 500 mL of the water in a constantly stirred beaker. The total amount of sodium sulfate added was 280 mg. Approximately 10 minutes after each incremental addition, the concentration of Sr⁺⁺ was measured and the wt % strontium removed was calculated by the difference from the initial amount present in the water. Table 1 gives the % of the sodium sulfate that was used for precipitating strontium.

TABLE 1

| Sample | % Na₂SO₄ added | Wt % Sr++ removed |
|---|---|---|
| 1 | 0 | 0 |
| 2 | 30 | 41.916 |
| 3 | 40 | 54.32 |
| 4 | 50 | 65.8 |
| 5 | 60 | 75.6 |
| 6 | 70 | 85.26 |
| 7 | 80 | 95.2 |
| 8 | 90 | 100 |
| 9 | 100 | 100 |
| 10 | 120 | 100 |

### Example 2

### Selective Precipitation of Strontium

Water containing strontium was first reacted with sulfuric acid based on the inlet strontium concentration, with 40% excess sulfuric acid being added to complete the formation of strontium sulfate in the water. The pH of the water was below 3.0.

1 L of produced water containing 442 mg/L strontium chloride, 6,200 mg/L calcium chloride, and 30 mg/L barium chloride (giving a Ca⁺⁺/Sr⁺⁺ wt ratio of 14.0 and molar ratio of 20.0) was used in this Example. The temperature was maintained at 25 deg C.

The relevant chemical precipitation reactions for this Example 2 are as follows:

SrCl₂+H₂SO₄→SrSO₄+2HCl

BaCl₂+H₂SO₄→BaSO₄+2HCl

After the reaction was complete, which took about 1 hour, the pH was increased to a range between 3.5 to 4.0, which caused the strontium sulfate and barium sulfate to precipitate while any calcium sulfate formed remained in solution. In particular, 7.81 mL of 0.5M sulfuric acid (Sigma Aldrich, Product #38294) was added to the 1 L of produced water and the flask was shaken thoroughly. White precipitate was formed, which was filtered and analyzed. The filtered water was also analyzed for strontium. This method allowed the barium and strontium to be removed while keeping the calcium in solution.

Analysis of the filtered water shows that the strontium concentration was 0.3 mg/L and analysis of the white precipitate obeyed the mass balance, since its dry weight was 79.7 g with 243.2 mg/Kg of barium and 3009 mg/Kg of strontium in the precipitate, indicating that all of the barium and almost all of the strontium had been precipitated as sulfates, while the calcium sulfate remained in solution.

The present invention may suitably comprise, consist of, or consist essentially of, any of the disclosed or recited elements. As used herein, the term “consisting essentially of” does not exclude the presence of additional equipment or materials which do not significantly affect the desired characteristics, properties, or use of a given composition, product, method, or apparatus. Further, the invention illustratively disclosed herein can be suitably practiced in the absence of any element which is not specifically disclosed herein. The various embodiments described above are provided by way of illustration only and should not be construed to limit the claims attached hereto. It will be recognized that various modifications and changes may be made without following the example embodiments and applications illustrated and described herein, and without departing from the true spirit and scope of the following claims.

We claim:

1. A composition comprising
a) seed crystals composed substantially of a target insoluble salt to be formed from a soluble salt;
b) a reagent capable of forming the target insoluble salt from the soluble salt, when the composition is in the presence of the soluble salt; and
c) water.

2. The composition of claim 1, wherein the seed crystals have an average particle size of about 30 to 100 microns.

3. The composition of claim 1, wherein the reagent is a water soluble sulfate salt.

4. The composition of claim 3, wherein the water soluble sulfate salt is substantially free of protonated sulfate adducts including sulfuric acid and metal hydrogen sulfates.

5. The composition of claim 3, wherein the water soluble sulfate salt is chosen from sodium sulfate, potassium sulfate, lithium sulfate, ammonium sulfate, and magnesium sulfate.

6. The composition of claim 1, wherein the reagent includes more than one soluble metal sulfate.

7. The composition of claim 1, further comprising one or more of surfactants, thermal stabilizers, water soluble polymers, water dispersible polymers, water soluble cosolvents, pH buffers, and adjuvants.

8. The composition of the slurry, wherein the pH of the composition is between about 6 and about 7.5.

9. The composition of claim 1, wherein the composition is substantially free of calcium salts.

10. The composition of claim 1, further comprising sodium chloride.

11. A slurry composition comprising
a) a water soluble sulfate salt,
b) seed crystals consisting essentially of strontium sulfate, the seed crystals having an average particle size of about 30 to 100 microns; and
c) water.

12. The slurry composition of claim 11 wherein the composition consists essentially of the recited substituents.

13. The slurry composition of claim 11 wherein the water soluble sulfate salt is sodium sulfate, potassium sulfate, magnesium sulfate, ammonium sulfate, lithium sulfate, or a combination of two or more thereof.

14. The slurry composition of claim 11 further comprising sodium chloride.

15. A method of separating a first soluble salt from a water product that contains the first soluble salt and a second soluble salt, the method comprising:
a) adding a composition to a water product containing a first soluble salt and a second soluble salt, the composition comprising seed crystals composed substantially of a target insoluble salt to be formed from the first soluble salt; and
b) collecting the target insoluble salt.

16. The method of claim 15, wherein the seed crystals have an average particle size of about 30 to 100 microns.

17. The method of claim 15, wherein the composition further comprises a reagent capable of forming the target insoluble salt from the first soluble salt.

18. The method of claim 17, wherein the composition further comprises water.

19. The method of claim 15, wherein the first soluble salt is a strontium salt.

20. The method of claim 15, wherein the target insoluble salt is strontium sulfate.

21. The method of claim 15, wherein the second soluble salt is a calcium salt.

22. A method of separating strontium from a water product, the method comprising
a) forming a slurry composition comprising a water soluble sulfate salt, seed crystals consisting essentially of strontium sulfate, and water, wherein the seed crystals have an average particle size of about 30 to 100 microns;
b) adding the slurry composition to a water product, the water product including at least one soluble strontium salt and one soluble calcium salt; and
c) collecting strontium sulfate.

23. The method of claim 22 wherein the ratio of calcium:strontium in the water product is between about 0.010:1 and 1000:1 on a weight:weight basis.

24. The method of claim 22 wherein precipitation of 90% to 100% by weight of measurable strontium dissolved in water is collected in the form of strontium sulfate, further wherein the precipitant includes less than about 0.1 to 10% calcium sulfate by weight.

25. The method of claim 22 further comprising washing the collected strontium sulfate with water.

26. The method of claim 22, further comprising partitioning a portion of the collected strontium sulfate and forming seed crystals from the partitioned strontium sulfate.

27. An apparatus for separating a first soluble salt from a water product that contains the first soluble salt and a second soluble salt, the apparatus comprising:
a) a source of a water product that contains a first soluble salt and a second soluble salt;
b) a tank for dispensing a composition into the water product to form a combined flow, the composition comprising seed crystals composed substantially of a target insoluble salt to be formed from the first soluble salt;
c) an in-line mixer adapted to mix the combined flow;
d) a precipitator vessel adapted to receive the mixed combined flow and separate treated water and a concentrated slurry of the target insoluble salt from the combined flow; and
e) a collecting apparatus adapted to receive the concentrated slurry of the target insoluble salt, to collect the target insoluble salt.

28. The apparatus of claim 27, wherein the seed crystals of the composition have an average particle size of about 30 to 100 microns.

29. The apparatus of claim 27, wherein the composition further comprises a reagent capable of forming the target insoluble salt from the first soluble salt.

30. The apparatus of claim 29, wherein the composition further comprises water.

31. The apparatus of claim 27, wherein the first soluble salt is a strontium salt.

32. The apparatus of claim 27, wherein the target insoluble salt is strontium sulfate.

33. The apparatus of claim 27, wherein the second soluble salt is a calcium salt.

34. An apparatus for collecting strontium sulfate from a water product, the water product including at least one soluble strontium salt and one soluble calcium salt, the apparatus comprising at least
a) a source of the water product;
b) a tank for dispensing a slurry composition of claim 1 into the water product to form a combined flow;
c) an in-line mixer adapted to mix the combined flow;
d) a precipitator vessel adapted to receive the mixed combined flow and separate treated water and a concentrated slurry of strontium sulfate from the combined flow; and
e) a collecting apparatus adapted to receive the concentrated slurry of strontium sulfate to collect the strontium sulfate.
